(19) United States
(12) Patent Application Publication
(10) Pub. No.: US 2004/0003835 A1
(43) Pub. Date: Jan. 8, 2004

(54) Higgins paint tool washer

(76) Inventor: Kevin C. Higgins, Snohomish, WA (US)

Correspondence Address: Kevin C. Higgins, 17902 Interurban Blvd., Snohomish, WA, 98296, US

(21) Appl. No.: 10/190,103

(22) Filed: Jul. 3, 2002

(51) Int. Cl. B08B 3/02

(52) U.S. Cl. 134/138; 134/900

(57) ABSTRACT

A machine for washing paint tools based on a vertically elongated square box of rigid transparent plastic comprising a housing (10) and a gasketed housing lid (12). Housing (10) is about sixty centimeters high at the back and about forty-two centimeters high at the front. The other two sides are about forty-two centimeters high for about half their distance from front to back then rise sharply to meet the back at its top. Bottom of lid (12) conforms to top contour of housing (10). Lid (12) is hinged at the top of the back side of housing (10), and has a handle (18) and seat (20) on its front side. On the front of housing (10) is a vertically adjustable roller handle seat (22) held perpendicular to the side of housing (10) by two seat guides (24) each in the shape of a square tube with two adjacent sides missing and closed ends. Guides (24) are mounted equidistant from the top and center of housing (10) with seat (22) between them so that edges of guides (24) enter vertical guide grooves (34) in each side of seat (22) and hold it close to and centered on housing (10). Seat (22) has on its bottom between guides (24) a lock screw tab (26) through which passes a lock screw (28) to impel against housing (10). Handle seat (22) is long enough and wide enough to seat a standard paint roller handle and has a longitudinal handle trough (30) on its top side and a longitudinal rabbet (32) in the bottom of trough (30) of a width and depth to accommodate miniature and long-necked paint roller handles. In the center of the top edge of the front side of housing (10) is a gasketed rounded notch about six centimeters wide and six centimeters deep. On the back of housing (10) is an off-centered, narrow, vertical guide slot (48) that starts neat the top of housing (10) and continues downward about three quarters of the length of housing (10). Passing through slot (48) is a solvent delivery system comprising valve (42), nozzle (44), and nipple (46) attached together. Valve (42) and nozzle (44) remain outside housing (10) while nipple (46) passes through slot (48), extending into housing where it is thickened so it can't come out of slot (48). Within housing (10), nipple (46) passes beyond the crest of a capped wattle (50) formed by brush-like members mounted vertically along each side of slot (48). On the top edge of one side of housing (10) just below lid (12) is a cutout about four centimeters wide and five centimeters deep forming a brush orifice (54). Orifice (54) is covered on the inside by a capped orifice wattle (56) formed by brush-like members mounted on each side of orifice (54). On one side of housing (10) near the bottom are mounting brackets (60) with clamp screws (62) which allow housing (10) to be mounted on the rim of a bucket or barrel. Housing (10) is open-bottomed.

### BACKGROUND

1. Field of Invention

This invention is a machine for washing paint tools.

2. Description of Prior Art

Professional painters, builders, remodeling contractors, property managers, and homeowners regularly encounter the need to wash paint tools. While paint-brushes are relatively easy to wash, paint rollers prove much more difficult to wash and require excessive amounts of time and water or other solvents for their cleaning.

The common methods of cleaning paint tools are to wash them in a container of solvent, in a sink, or with a hose. By any of these methods the washing of paint rollers is messy, time consuming, aggravating, and uses large amounts of water or other solvent. These methods also usually result in the solvent and paint being released into the sewers or into the ground, creating environmental hazards.

Furthermore, it is quite difficult to achieve satisfactory results in washing paint rollers by any of these methods.

Another option commonly practiced by those faced with the problem of cleaning paint rollers is to simply discard the roller pads in the garbage. This too is wasteful of resources and environmentally unsound.

### OBJECTS AND ADVANTAGES

Several objects and advantages of my invention are:

(a) to greatly reduce the time required for the cleaning of all kinds of paint tools, particularly paint rollers;

(b) to greatly reduce the amount of water or other solvent needed to clean paint tools, particularly paint rollers;

(c) to facilitate the easy capture of the solvent and paint for reuse or proper disposal;

(d) to produce much more satisfactory results in the cleaning of paint rollers than by common methods;

(e) to greatly extend the useful life of paint tools, especially paint roller pads;

(f) to eliminate the aggravation and futility of trying to clean paint rollers by the usual methods;

(g) to clean paint tools with much less mess created than by common methods.

Further objects and advantages include the monetary savings and environmental benefits to be realized through the advantages listed above. These savings and benefits would accumulate significantly for professional painters and other contractors as well as for landlords and property managers.

These objects and advantages will become apparent through a consideration of the ensuing descriptions and drawings.

### DRAWINGS FIGURES

FIG. 1 shows the entire paint tool washer with transparent housing in closed position.

FIG. 2 shows the paint tool washer in open position from the opposite side to FIG. 1 with transparent housing.

FIG. 3 shows the paint tool washer in closed position from the same side as FIG. 2 but from a different angle with housing shown non-transparent for clarity of external aspects.

FIG. 4 is an exploded view of the assemblage of the paint roller handle seat, the seat guides, the adjustment lock screw, and their way of mounting to one side of housing.

FIG. 5 is an exploded view of the assemblage of the solvent valve, solvent nozzle, nozzle ring, solvent spray nipple, nipple ring, spray nipple wattle, and wattle cap and their way of mounting to one side of the housing through the nipple guide slot.

### REFERENCE NUMERALS IN DRAWINGS

| | | | |
|---|---|---|---|
| (10) | housing | (66) | threaded hole |
| (14) | hinges | (70) | nipple ring |
| (18) | lid handle | (74) | wattle screws |
| (22) | roller handle seat | (12) | housing lid |
| (26) | lock screw tab | (16) | lid gasket |
| (30) | handle trough | (20) | lid seat |
| (34) | guide grooves | (24) | seat guides |
| (38) | roller handle neck orifice | (28) | lock screw |
| (42) | solvent valve | (32) | handle rabbet |
| (46) | solvent spray nipple | (36) | hand grip |
| (50) | spray nipple wattle | (40) | neck orifice gasket |
| (54) | brush orifice | (44) | solvent nozzle |
| (58) | brush orifice cap | (48) | nipple guide slot |
| (62) | mounting clamp screws | (52) | wattle cap |
| (60) | mounting brackets | (56) | brush orifice wattle |
| (64) | seat guide screws | (68) | nozzle ring |
| | | (72) | wattle cap screws |

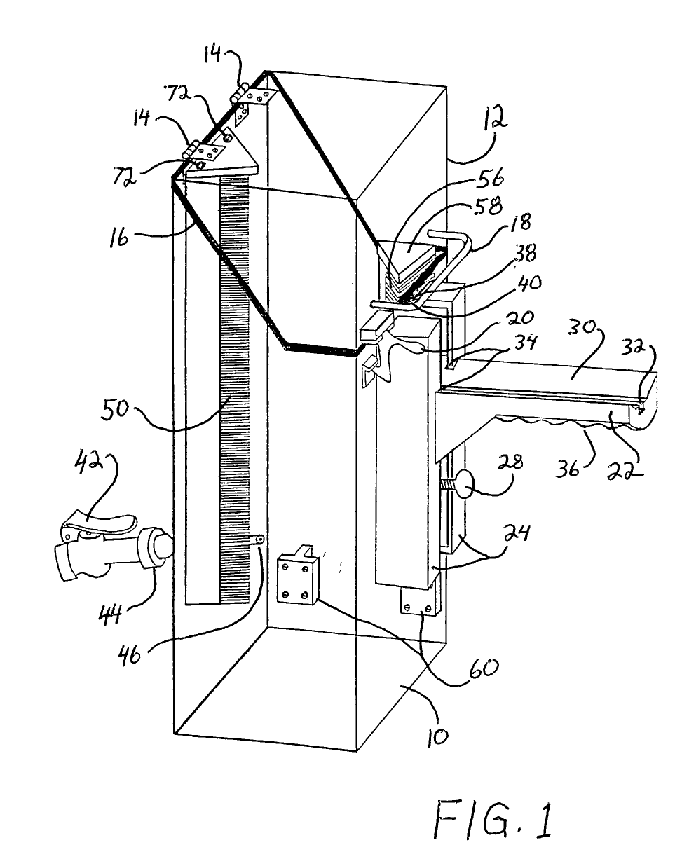

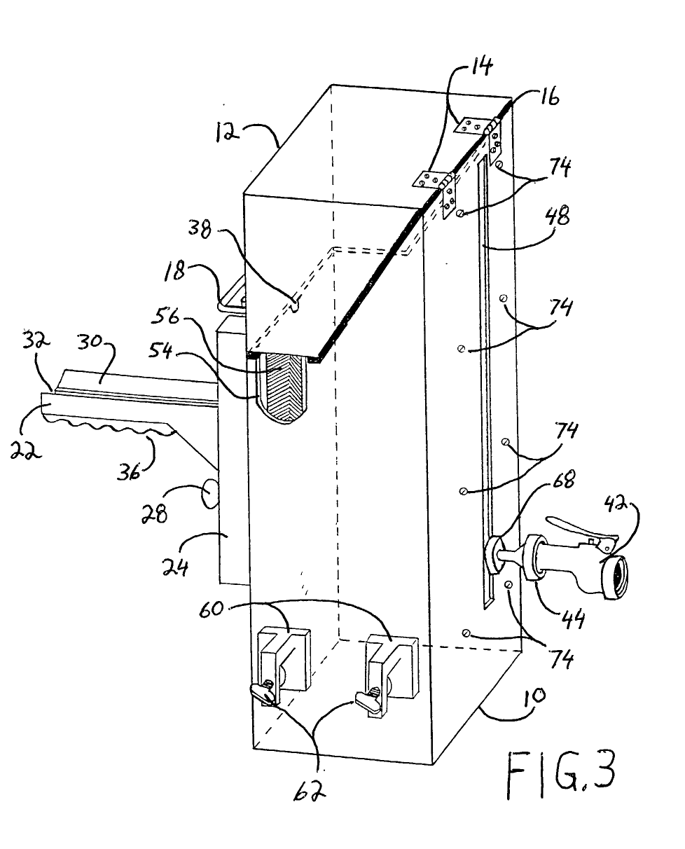

Description—FIGS. 1, 2, and 3

A typical embodiment of the paint tool washer of the present invention is illustrated in FIGS. 1, 2, and 3. The paint tool washer is built around and within a housing 10 made of a rigid or semi-rigid transparent plastic of approximately three millimeters thickness. In the preferred embodiment housing 10 is in the form of a vertically elongated box approximately sixty centimeters high and eighteen centimeters wide with an open bottom. The back side of housing 10 is approximately eighteen centimeters higher than the front side. The other two sides are symmetrical. They are the same height as the front side for about half their width from front to back and then they rise abruptly to meet the back side at its top.

On top of housing 10 is a housing lid 12 that completes the elongated box shape of housing 10. Housing lid 12 is attached to housing 10 by hinges 14 that allow lid 12 to be opened and closed. Lid 12 is constructed of similar material to housing 10.

Housing lid 12 has attached to it a lid gasket 16 of rubber or a rubber-like material that seals together all the edges where housing 10 and lid 12 meet.

Housing lid 12 has attached to its front a lid handle 18 to facilitate its opening and closing. Handle 18 in the preferred embodiment is of the squared-loop cabinet handle type.

Housing lid 12 has attached to it a lid sear 20 placed near lid handle 18. Lid sear 20 automatically locks lid 12 in the closed position when lid 12 is put down. Sear 20 in the preferred embodiment is of the common thumb operated cabinet door catch type. Sear 20 is placed near handle 18 so that both may be operated simultaneously with one hand.

On the front side of housing 10 is mounted a vertically adjustable roller handle seat 22. Roller handle seat 22 extends outward about twenty eight centimeters from the side of housing 10. Handle seat 22 is mounted between two seat guides 24, which are attached to housing 10.

Roller seat 22 is about four centimeters wide for its entire length. Handle seat 22 is about three centimeters thick from top to bottom for approximately the outer two thirds of its length. From about one third of its length outward from housing 10 handle seat 22 angles downward from its bottom toward housing 10 to have a thickness of about eight centimeters where it meets seat guides 24. Within and between seat guides 24 handle seat 22 extends downward about another four centimeters. This downward extension creates a lock screw tab 26 on the lower side of handle seat 22 through which a lock screw 28 passes to lock handle seat 22 in position vertically.

The top of roller handle seat 22 has a wide syncline handle trough 30 which is the width of handle seat 22 at the top and narrows downward toward the lineal middle of handle seat 22. Handle trough 30 extends downward into handle seat 22 about twelve millimeters at which level is has a flattened bottom about twelve millimeters wide. In the middle of the flat bottom of handle trough 30 is a handle rabbet 32 about six millimeters wide and six millimeters deep. Trough 30 and rabbet 32 run the full length of handle seat 22.

There are vertical guide grooves 34 on each side of roller handle seat 22 about one centimeter from the end of handle seat 22 that abuts housing 10. These guide grooves 34 are about six millimeters wide and six millimeters deep.

For the outer two thirds of its length from housing 10 the sides of handle seat 22 slant inward toward its bottom. Along the bottom of this part of handle seat 22 are undulated cusps forming a comfortable hand grip 36.

Seat guides 24 are each in the shape of a square tube with two adjacent sides missing and closed ends. Guides 24 are mounted about twenty-five millimeters apart at equal height on the front side of housing 10. Guides 24 are each mounted with one open side toward housing 10 and their other open sides facing each other.

Seat guides 24 are mounted to the side of housing 10 with roller handle seat 22 between them. Seat guides 24 are of such a depth that the edges of their outer sides will enter guide grooves 34 on either side of handle seat 22, holding handle seat 22 at approximate right angles vertically and horizontally to the side of housing 10. Handle seat 22 is held so that trough 30 and rabbet 32 line up to the center of housing 10.

In the center of the top edge of the front side of housing 10 is a rounded notch about six millimeters wide and six millimeters deep. This notch forms a roller handle neck orifice 38. Neck orifice 38 is covered by a rubber or rubber-like neck orifice gasket 40 on the inside of housing 10. Orifice gasket 40 may be flat, incurvate, nipple-shape, or other shapes. A flat orifice gasket 40 is preferred as being simplest and most economical to manufacture.

On the taller back side of housing 10 there is mounted on the outside a solvent valve 42. In the embodiment of the invention shown solvent valve 42 is of the common thumb operated type made to attach to a standard garden hose. In this embodiment the solvent used would be water. Other types of valves and solvent supply systems have been considered but the thumb valve for water is illustrated as the most commonly useful type.

Solvent valve 42 has attached to its outflow side a solvent nozzle 44 that reduces the solvent flow pathway from about twenty two millimeters to about six millimeters in diameter. Attached to solvent nozzle 44 is a solvent spray nipple 46. Spray nipple 46 has the shape of a tube of approximately six millimeters outside diameter and three millimeters inside diameter and approximately five centimeters length. Spray nipple 46 passes through a vertical nipple guide slot 48 in the back side of housing 10. Guide slot 48 is formed by a long narrow vertical cutout in the back side of housing 10. Slot 48 is about one centimeter wide and forty four centimeters long and it is offset from the center of housing 10 by about twenty five millimeters. The top of slot 48 is about twelve millimeters down from the top of housing 10.

Mounted to the inside surface of the back side of housing 10 directly over guide slot 48 is a spray nipple wattle 50. Spray nipple wattle 50 is formed by two thin elongated brush-like members mounted on either side of guide slot 48 and tilted toward each other so that they mesh together in a Salient crest centered on guide slot 48. Viewed from the top or bottom nipple wattle 50 would appear triangular in shape.

Covering the top of nipple wattle 50 is a triangular wattle cap 52. Wattle 50 and cap 52 prevent the escape of solvent and paint through nipple guide slot 48 when the paint tool washer is in use.

Solvent spray nipple 46 extends inside housing 10 slightly beyond the intermeshed crest of nipple wattle 50.

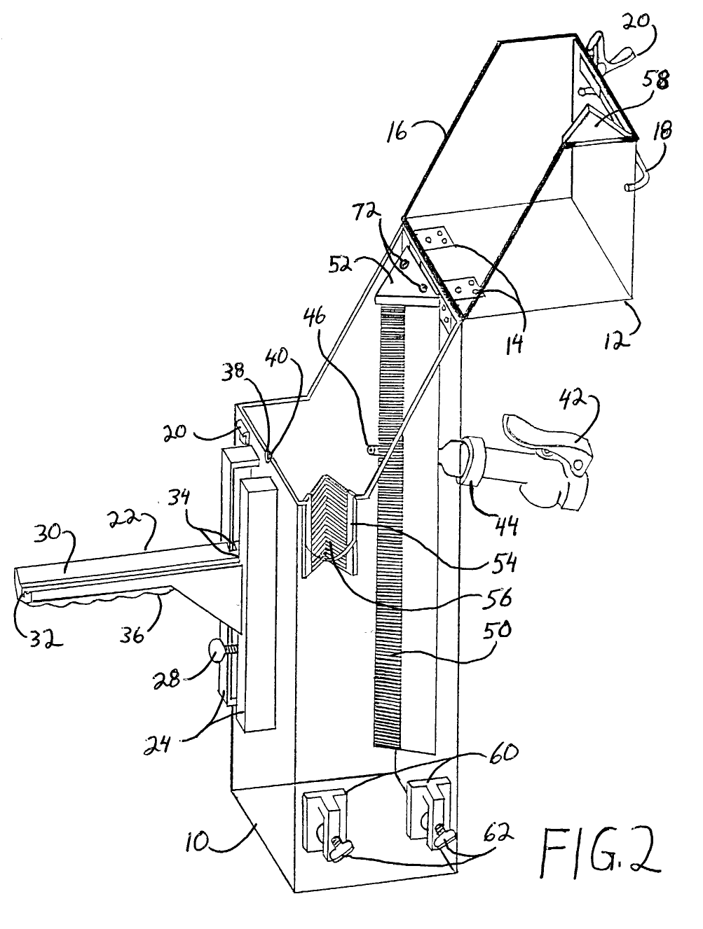

When the paint tool washer is viewed with handle seat 22 on the left and solvent valve 42 on the right as in FIG. 2 the side facing the viewer has a brush orifice 54. Brush orifice 54 is created by a cutout in the side of housing 10 at the top where it remains equal in height to the front side. The cutout for brush orifice 54 is approximately four centimeters wide and five centimeters deep.

Mounted inside housing 10 directly over brush orifice 54 is a brush orifice wattle 56. Brush orifice wattle 56 is formed similarly to spray nipple wattle 50 by two brush-like members mounted on either side of brush orifice 54 and tilted toward each other so that they mesh together in a salient crest centered on brush orifice 54. On the inside of housing lid 12 is mounted a triangular brush orifice cap 58 in such a position that it covers the top of brush orifice wattle 56 when housing lid is closed.

Orifice wattle 56 and orifice cap 58 prevent the escape of solvent and paint through brush orifice 54 when the paint tool washer is in use.

On the same side of housing 10 that features brush orifice 54 are affixed two mounting brackets 60 near the bottom on the outside of housing 10. Mounting brackets 60 are members made of rigid plastic or other rigid material that protrude about five centimeters outward from housing 10 and then about five centimeters downward forming inverted brackets, which allow the paint tool washer to hang on the edge of a bucket, barrel, or other solvent and paint receptacle. The vertical portions of mounting brackets 60 each have mounting clamp screws 62 passing through them toward housing 10. Clamp screws 60 allow the paint tool washer to be securely mounted to the bucket, barrel, or other solvent receptacle. Other types and positioning of mounting clamps and brackets have been considered, but those illustrated in the present embodiment seem the most economical to manufacture.

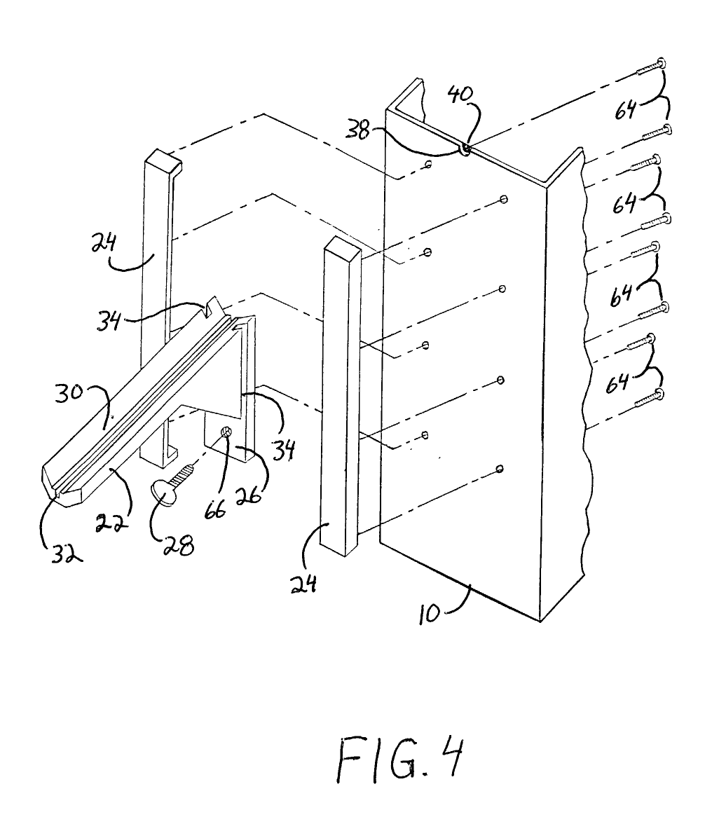

Description—FIG. 4

The preferred method of assembling roller handle seat 22, seat guides 24, and lock screw 28 and mounting them to one side of housing 10 is illustrated in exploded view in FIG. 4.

Seat guides 24 are attached to the front of housing 10 by seat guide screws 64 which pass through the side of housing 10 and into one vertical edge of seat guides 24. Four seat guide screws 64 per seat guide 24 are illustrated but the number may be varied. Seat guides 24 are mounted parallel to each other and equidistant from the middle of housing 10 with one open side toward housing 10 and their other open sides toward each other. Seat guides 24 are mounted about twenty eight millimeters apart. Seat guides 24 are mounted to the side of housing 10 with roller handle seat 22 between them so that the edges of seat guides 24 that face each other enter guide grooves 34 on either side of handle seat 22. In this way seat guides 24 hold handle seat 22 close to the side of housing 10 and perpendicular horizontally and vertically to the side of housing 10. Handle seat 22 is held with handle trough 30 and handle rabbet 32 aligned toward the midpoint of the side of housing 10. Handle seat 22 is held by seat guides 24 with enough clearance between all surfaces that it is unbound and may slide freely up and down between seat guides 24 when lock screw 28 is loosened.

Lock screw 28 passes through a threaded hole 66 in lock screw tab 26 and when screwed inward will impel against the side of housing 10.

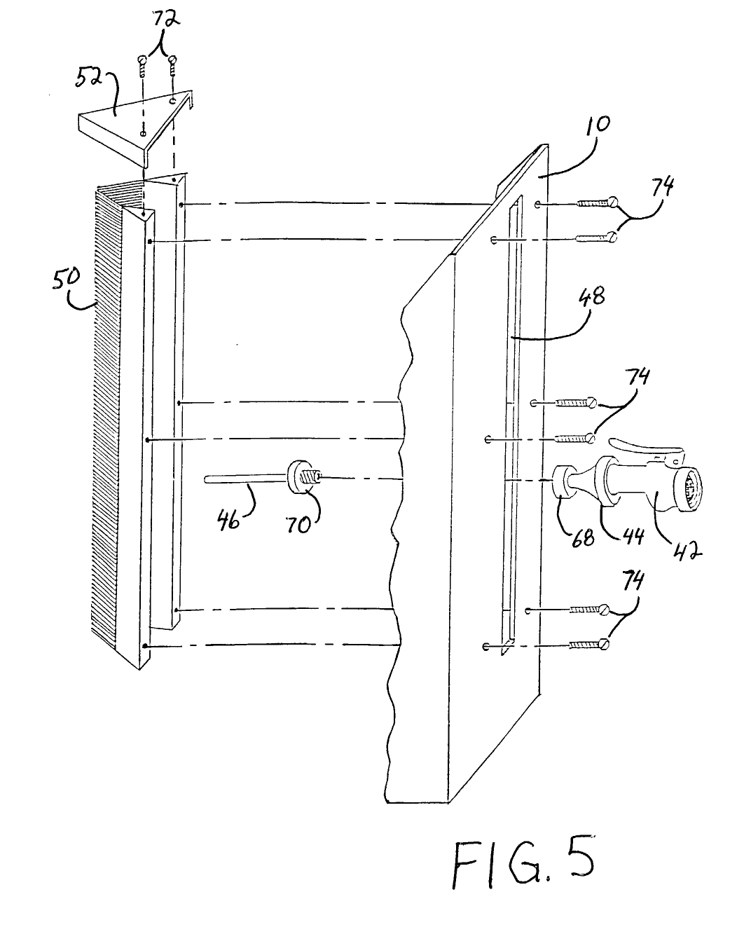

Description—FIG. 5

The preferred method of assembling solvent valve 42, solvent nozzle 44, nozzle ring 68, solvent spray nipple 46, and nipple ring 70, and attaching wattle 50, and wattle cap 52 to the back side of housing 10 is illustrated in FIG. 5.

In the preferred embodiment a common “thumb valve” type of water valve serves as solvent valve 42. Solvent valve 42 has attached to its outflow side a solvent nozzle 44, which constricts the solvent flow pathway from about twenty two millimeters to about six millimeters outside diameter. Valve 42, nozzle 44, and nozzle ring 68, are oriented perpendicularly to the back side of housing 10 and to nipple guide slot 48.

Guide slot 48 is formed by a long narrow vertical cutout in the back side of housing 10. Slot 48 is about one centimeter wide and forty four centimeters long and it is offset from the center of housing 10 by about twenty five millimeters. The top of slot 48 is about twelve millimeters down from the top of housing 10.

On the inside of housing 10 is a solvent spray nipple 46 in the shape of a tube of about six millimeters outside diameter and about three millimeters inside diameter, and about five centimeters length. Spray nipple 46 extends through nipple guide slot 48 in the side of housing 10. Spray nipple 46 extends from the inside to the outside of housing 10 where it is threaded into solvent nozzle 44. About one centimeter from the inflow end of spray nipple 46 is a nipple ring 70 which prevents spray nipple 46 from passing all the way out through guide slot 48.

When assembled this way, valve 42, nozzle 44, and spray nipple 46 will hang loosely on the side of housing 10 and will slide freely up and down guide slot 48, pivoting to a small degree at the point of passage through the side of housing 10.

Mounted to the inside surface of the backside of housing 10, directly over guide slot 48, is a spray nipple wattle 50. Spray nipple wattle 50 is formed by two thin elongated brush-like members mounted on either side of guide slot 48 and tilted toward each other, meshing together in a salient crest centered on guide slot 48. Viewed from the top or bottom nipple wattle 50 would appear to have a triangular shape. Covering the top of nipple wattle 50 is a wattle cap 52.

Wattle cap 52 is attached to the top of nipple wattle 50 with wattle cap screws 72.

Nipple wattle 50 is attached to the side of housing 10 with wattle screws 74.

Operation—FIGS. 1 to 5

The manner of using the paint tool washer to wash common paint rollers is as follows.

The user first mounts the paint tool washer on the edge of a bucket, barrel, or other solvent receptacle by use of mounting brackets 60 and mounting clamp screws. The paint tool washer is placed inside the solvent receptacle in such a way that brackets 60 rest on the rim of the receptacle and clamp screws 62 may be tightened against the outside of the receptacle. When mounted this way the paint tool washer will hang stationary on the edge of the bucket or other receptacle.

The user next attaches a pressurized solvent supply to solvent valve 42. In the present embodiment the solvent supply would be a common garden hose and the solvent would be water.

The user next opens the paint tool washer by grasping lid handle 18, releasing lid sear 20, and lifting housing lid 12. Housing lid 12 will open far enough that it rests in the open position.

A common paint roller handle, with a paint-laden roller pad still affixed, is then placed in handle trough 30 on roller handle seat 22 of the paint tool washer in such a way that the wider hand grip part of the roller handle rests in trough 30. The narrower bent-rod neck of the roller handle reaches up and through neck orifice 38 of the paint tool washer. The rolling bail part of the paint handle with the roller pad still affixed is then hanging vertically within the paint tool washer.

The user next loosens lock screw 28 and may slide handle seat 22 up or down between seat guide 24 until the paint roller handle with the pad to be cleaned rests snugly on both handle trough 30 and neck orifice 38. When proper vertical adjustment of handle seat 22 is achieved, the user tightens lock screw 28 so that it impels against housing 10 and locks handle seat 22 in place.

Housing lid 12 is then closed so lid sear 20 catches and holds it closed. In this way the wire neck of the common paint roller handle is held fast in neck orifice 38.

When the paint roller handle is then grasped firmly together with handle seat 22 on which it rests, the paint roller pad to be cleaned will be held vertically within the paint tool washer, touching no surfaces. The paint roller pad to be cleaned is also held parallel to the movement of spray nipple 46 along guide slot 48.

When the roller pad to be cleaned is thus closed inside housing 10 of the paint tool washer still affixed to the rolling bail of the common paint roller handle, the cleaning process may begin.

The user grasps the paint roller handle and handle seat 22 together with one hand and with another hand grasps solvent valve 42. When solvent valve 42 is opened, the pressurized solvent flows through nozzle 44 and nipple 46. The solvent flow is constricted by nozzle 44 into nipple 46 so that the solvent emerges from nipple 46 in a jet-like sparge directed toward the common roller pad to be cleaned. The hand that grasps nozzle 44 can then manipulate spray nipple 46 up and down in guide slot 48.

When the solvent sparge from the spray nipple 46 is directed alternately toward the center and the edge of the roller pad to be cleaned the roller pad will spin slowly on the bail of the common roller handle and will load up with solvent. When nipple 46 is moved up and down guide slot 48 the whole length of the roller pad can be loaded up with solvent.

When the solvent sparge is directed more toward the edge of the roller pad, it will begin to spin faster and will begin to cast off solvent and paint by efferent centrifugal force. When the optimum angle of the solvent sparge to the roller pad is found, the roller pad will spin extremely fast and create a tremendous centrifugal cleaning force. By slightly varying the angle of the solvent sparge, the roller pad can be made to spin alternately slower and faster, thus alternately loading up and casting off solvent.

Because the paint roller handle is grasped firmly to handle seat 22 and shut tight in neck orifice 38, the roller pad being cleaned will remain in proper position and orientation within housing 10.

The open-bottomed housing 10 contains the spun off solvent and paint and causes it to fall into the solvent receptacle to which the paint tool washer is mounted.

Because housing 10 is transparent, the cleaning process can be viewed by the user for maximum efficiency and enjoyment.

Neck orifice gasket 40 prevents the spun-off solvent and paint from escaping through neck orifice 38.

Brush orifice wattle 56 and orifice cap 58 prevent the spun-off solvent and paint from escaping through brush orifice 54.

Spray nipple wattle 50 and wattle cap 52 prevent the solvent and paint from escaping past spray nipple 46 and through guide slot 48.

Lid gasket 16 prevents the solvent and paint from escaping between housing 10 and lid 12.

When the paint roller pad appears to be sufficiently cleaned, it can be removed from the paint tool washer and examined. It can be stored, used again, or given further cleaning if necessary.

With minimal practice, a person can take a paint roller pad fully loaded with paint and, after cleaning in the paint tool washer, pull it out perfectly clean and nearly dry, so that it can be used again immediately, even with a different color of paint. This is achieved in much less time and using much less water or other solvent than other methods of washing paint roller pads.

Some paint roller handles are extended by a lengthening of the straight wire part between the hand grip and the neck. This lengthening of the wire part of the roller handle prevents the hand grip part from resting in handle trough 30. These roller handles may be accommodated by resting the extended wire part of their handles in handle rabbet 32 at the bottom of trough 30.

Handle rabbet 32 is also intended to accommodate the small plastic handles of miniature trim rollers, which can be cleaned in the same manner as standard paint rollers.

If a person has a standard paint roller pad mounted in a splatter guard shielded type of roller handle, this can also be cleaned in the paint tool washer. This is done, by opening lid 12 and placing the roller pad holder inside the paint tool washer with its handle extending out through brush orifice 54.

Housing lid 12 is then closed and the paint roller pad is cleaned as on a standard roller handle by manipulating the sparge of solvent from spray nipple 46. The handle of shielded roller pad holder extends out through brush orifice 54 and is gripped firmly with one hand, while another hand operates solvent valve 42 and spray nipple 46. The height of lid 12 allows half of the shielded roller pad holder to extend above brush orifice 54, while the other half extends below.

The brush-like members that form the salient crest of brush orifice wattle 56 will conform around the handle placed between and along with orifice cap 58 will prevent the escape of spun-off solvent and paint through brush orifice 54.

If a person has a paint roller that is pressure-fed through its handle, this may be cleaned in the paint tool washer by enclosing it in housing 10 with its handle extending out through brush orifice 54.

Various types and sizes of paint brushes can also be washed in the paint tool washer. These are washed by opening lid 12 and placing the brush end of the tool inside housing 10 with the handle end extending out through brush orifice 54. Lid 23 is then closed and the paint brush handle is grasped with one hand while another hand operates solvent valve 42 and spray nipple 46 to clean the paint brush.

The brush-like members that form the crest of orifice wattle 56 will conform around the paint brush handle and, along with orifice cap 58, will prevent the escape of solvent and paint through brush orifice 54.

As with paint roller pads, the cleaning of paint brushes is much faster and more efficient with the paint tool washer, and the solvent and paint are easily recovered for proper disposal.

Summary, Ramifications, and Scope of Invention

With the description of the operation of FIGS. 1 to 5 provided, the reader should recognize that the paint tool washer of the present invention provides an easy, efficient, and fun means of washing almost any paint tool on the market.

The paint tool washer would be a valuable and worthwhile investment for professional painters, builders, and remodeling contractors. It would also be a worthwhile investment for homeowners, landlords, and property managers.

The paint tool washer could be made compact, lightweight, and available at a reasonable price. It could be made in a heavy-duty professional grade and in a light-duty occasional use grade.

Because the paint tool washer cleans paint tools using much less water or other solvent than other methods, the water or other solvent saved would quickly offset the cost of the paint tool washer. The water saved would also accumulate to a significant environmental benefit.

Because the paint tool washer cleans paint tools so easily and so thoroughly, the useful life of the tools, especially paint roller pads, is greatly extended. This would also reduce the amount of landfill space taken up by paint tools, and would reduce the amount of resources consumed by the manufacture of tools.

Because the paint tool washer cleans paint tools very quickly, the time saved would soon offset the cost of the paint tool washer.

While the above description contains many specificitys, these should not be construed as limitations on the scope of the invention, but rather as an exemplification of one preferred embodiment thereof. Many other variations are possible. For example housing 10 might be of a shape other than the elongated square box shape illustrated. Housing 10 might also be in a round box shape or have any number of sides. The square box shape is preferred as being most economical to manufacture and most stable in freestanding use.

Housing 10 might be manufactured by various means including folding and piecing together of flat stock material or by purpose casting of molded pieces. Mounting brackets 60, seat guides hinges 14, lid handle 18, lid sear 20, or other parts might be integrated to the casting of a molded plastic housing 10.

Housing 10 in other embodiments might have a closed bottom and an attached solvent recovery and/or recycle system. However, the open-bottom configuration seems most commonly useful.

The vertical orientation of the paint tools within the machine is not integral to the essence of the invention but seems preferable to a horizontal or skewed orientation.

Lid handle 18 and lid sear 20 might be of different styles or even eliminated in other embodiments.

Roller handle seat 22 might be altered in various ways without effecting the essence of the invention. Seat 22 might be rounder in end profile and may or may not have an undulated hand grip 36, and the downward slanting part on its bottom may be eliminated.

Roller handle seat 22 might have other features to hold down or stabilize the paint roller handle seated there. Handle seat 22 might also have locking mechanisms other than lock screw 28. One possibility would be a flip-up, flip-down, or flip-sideways cam lock. Another possibility would be a spring pin or spring catch with multiple positions and trigger operation.

Handle trough 30 and handle rabbet 32 might be alternately more rounded or more syncline.

Handle seat 22 might be centered or off-centered on housing 10. Other methods of mounting and assembling solvent valve 42, solvent nozzle 44, and spray nipple 46, may also be used without effecting the essence of the invention.

Spray nipple wattle 50 might be eliminated and other means of gasketing and guiding spray nipple 48 employed. Guide slot might be centered or off-centered on housing 10.

Solvent valve 42 and spray nipple 46 might have multiple spray functions including, but not limited to, pressure variance, various spray patterns, and sideways spray capability. A sideways spray capability might be employed as a means to rinse the inside of housing 10. Solvent valve 42 might also be of a different design than that illustrated, or may be eliminated in other embodiments.

In other embodiments of the invention pressurized air might be used in mixture or in conjunction with the solvent sparge employed, or as the sole solvent.

Hinges 14 might be of different design from those illustrated or they might be integrally cast members of housing 10 and/or lid 12.

Lid gasket 16, wattle cap 52, and brush orifice cap 58 might have various profiles and features without effecting the essence of the invention, or they may be shaped or located differently than illustrated, or they may be eliminated in other embodiments of the invention.

Mounting brackets 60 may be of various shapes and configurations, and they may be integrally cast members of a molded housing 10, or they may be eliminated.

Other mounting lock devices might also be employed, including but not limited to flip-cam types.

In other embodiments of the invention, housing lid 12 might be larger or smaller, or shaped differently, perhaps domed.

In another embodiment of the invention, the paint tool washer might allow hands-free, motor driven operation.

Housing 10 and other parts may or may not be transparent in other embodiments and may be made of other materials than plastic.

Housing 10 and other parts may be assembled by various means including, but not limited to, the use of adhesives and mechanical fasteners.

Nozzle ring 68 and nipple ring 70 might be of various shapes and sizes, or may be eliminated in other embodiments of the invention.

Solvent pumps and/or recovery and recycle systems might be employed in other embodiments.

The present embodiment and other embodiments might be employed to clean things other than paint tools.

Juxtaposition of features on the paint tool washer may be varied without effecting the essence of the invention. However, the arrangement shown is preferred as most ergonomically correct.

All measurement provided are nominal and merely illustrative of relative sizes and proportions.

Thus, the scope of the invention should be determined by the appended claims and their legal equivalents rather than by examples given.

I claim:

1. A machine for washing paint tools comprising:
a. a housing in which a standard paint roller pad may be enclosed while mounted on a standard paint roller handle, and
b. A solvent delivery system that passes through one side of said housing and moves lineally parallel to said standard paint roller pad delivering a sparge of solvent to length of said standard paint roller pad
c. Whereby said standard paint roller pad may be thoroughly and rapidly cleaned with efferent centrifugal force when said sparge of solvent causes said standard paint roller pad to spin and the solvent and paint cast off may be contained and captured.

2. The machine of claim 1, wherein said housing is transparent.

3. The machine of claim 1, further including a roller handle seat on the outside of said housing on which can be rested said standard paint roller handle with it's roller pad closed inside said housing.

4. The roller-handle seat of claim 3, wherein said roller handle seat is vertically adjustable to accommodate various sizes of paint roller handles.

5. The roller-handle seat of claim 3, further including a handle trough to more securely seat said standard paint roller handle.

6. The roller-handle seat of claim 3, further including a narrow rabbet or groove for seating paint roller handles with long necks and miniature paint roller-handles.

7. The roller-handle seat of claim 3, wherein said standard paint roller handles and said roller-handle seat may be comfortably clasped together by a person's hand.

8. The machine of claim 1, further including a paint brush orifice through which a standard paint brush handle may pass to the outside of said housing with said standard paint brush enclosed within said housing.

9. The machine of claim 1, wherein said solvent delivery system passes through and slides along a slot in one side of said housing.

10. The machine of claim 1, further including wattles formed by brushes meshing together to cover openings in said housing.

11. The machine of claim 1, further including brackets to facilitate the mounting of said machine on the rim of a solvent receptacle.

12. The mounting brackets of claim 9, further including clamping devices.

13. The machine of claim 1, further including hinged lid to allow access to said housing.

14. The hinged lid of claim 13 wherein clearance is provided to accommodate standard shielded paint roller holders.

15. The hinged lid of claim 13, further including handle and lid sear positioned to be operated simultaneously with one hand.
